(19) United States
(12) Patent Application Publication
(10) Pub. No.: US 2011/0211240 A1
(43) Pub. Date: Sep. 1, 2011

(54) IMAGE DISPLAY DEVICE

(75) Inventor: Michihiro TAKEDA, Kiyosu-shi (JP)

(73) Assignee: BROTHER KOGYO KABUSHIKI KAISHA, Nagoya-shi (JP)

(21) Appl. No.: 13/033,267

(22) Filed: Feb. 23, 2011

(30) Foreign Application Priority Data
Feb. 26, 2010 (JP) 2010-042799

(51) Int. Cl. G09G 5/10; G02B 26/10

(52) U.S. Cl. 359/197.1; 345/690; 345/691

(57) ABSTRACT

An image display device which can, even when a laser beam source which has a kink region in the input-output characteristic thereof is used, easily reproduce a low gradation level with high accuracy, and can reduce undesired radiation due to a high-frequency signal is provided. The image display device includes a signal generation part which generates the image signal at a period corresponding to the scanning speed of the scanning part in accordance with every pixel, and a signal adjustment part which superposes a high-frequency signal having a period equal to or more than a period at which the image signal is generated. The signal adjustment part superposes the high-frequency signal on the image signal by changing the period of the high-frequency signal corresponding to the period at which the image signal is generated.

### CROSS-REFERENCE TO RELATED APPLICATIONS

This application is based on and claims the benefit of priority from Japanese Patent Application No. 2010-042799 filed on Feb. 26, 2010, the entire contents of which are incorporated herein by reference.

### BACKGROUND

1. Field

The present invention relates to an image display device, and more particularly to an image display device provided with a laser beam source which irradiates a laser beam having intensity corresponding to an image signal.

2. Description of the Related Art

Conventionally, there has been known a scanning image display device in which a laser beam whose intensity is modulated in response to an image signal is irradiated from a laser beam source, the laser beam is scanned by a scanning part in two-dimensional directions, and the laser beam is projected onto a projecting object thus displaying an image. As this type of image display device, there have been known a retinal scanning display in which a retina of a user is used as the projecting object and a screen scanning image display device in which a screen is used as the projecting object, for example.

When an image displayed by the scanning image display device is a color image, it is necessary to provide a plurality of laser beam sources which generate a plurality of laser beams of different wavelengths respectively. In general, the scanning image display device uses a red laser beam source, a green laser beam source and a blue laser beam source. By converging laser beams irradiated from these laser beam sources on the same optical path, the laser beams are synthesized thus producing a laser beam of various colors (see JP 2003-295108 A, for example).

### SUMMARY OF THE INVENTION

When a semiconductor laser is used as such a laser beam source, there has been known a semiconductor laser in which an input-output characteristic (current-light output characteristic) is steeply changed so that a bent portion is formed thus giving rise to a region where linearity collapses. It is desirable that the input-output characteristic smoothly continues from a first region where the increase/decrease of output intensity of light with respect to the increase/decrease of an electric current is gentle to a second region where the increase/decrease of the output intensity of the light is steep. However, there has been known a semiconductor laser in which an input-output characteristic has a third region where the increase/decrease of output intensity of light is steeper than the increase/decrease of output intensity of light of the second region between the first region and the second region. Such a third region is called a kink region. This kink region appears conspicuously with respect to the green laser beam source and a blue laser beam source.

In a case where the input-output characteristic of the semiconductor laser has such a kink region, when an image signal (image signal in accordance with every pixel) to which a gradation level is allocated on the presumption that the input-output characteristic has linearity is outputted to the semiconductor laser, a gradation crush occurs at a low gradation level.

Accordingly, when the semiconductor laser is used as a laser beam source, it is necessary to allocate an image signal at each gradation level corresponding to the above-mentioned kink region. However, this allocation processing is difficult so that the low gradation level cannot be accurately reproduced.

In view of the above, inventors of the present invention have made extensive studies and have made a finding that a steep change of the output intensity of light which occurs in the kink region can be made substantially gentle by superposing a high-frequency signal on an image signal formed in accordance with every pixel corresponding to a gradation level of a pixel which constitutes an image.

Accordingly, by superposing the high-frequency signal on the image signal in this manner, even when a laser beam source has a kink region in the input-output characteristic thereof, the laser beam source can easily reproduce a low gradation level with high accuracy. Here, the high-frequency signal is an AC signal having a frequency which is equal to or larger than the inverse of a generation period of an image signal and an amplitude equal to or larger than a width of the kink region where the input-output characteristic of the laser beam source is changed most steeply.

However, in displaying an image corresponding to an image signal, a high-frequency signal is generated and hence, there exists a possibility that undesired radiation occurs due to the high-frequency signal. Particularly, when a kink region is large so that it is necessary to increase amplitude of the high-frequency signal or the like, the undesired radiation which occurs due to the high-frequency signal is also increased.

The present invention has been made under such circumstances, and it is an object of the present invention to provide an image display device which can easily and accurately reproduce a low gradation level, and can decrease undesired radiation due to a high-frequency signal even when a laser beam source having a kink region in an input-output characteristic thereof is used.

According to one aspect of the present invention, there is provided an image display device which includes: a laser beam source which irradiates a laser beam having intensity corresponding to an image signal; a scanning part which scans the laser beam which is irradiated from the laser beam source at a scanning speed corresponding to a scanning position; a signal generation part which generates the image signal at a period corresponding to the scanning speed of the scanning part in accordance with every pixel; and a signal adjustment part which superposes a high-frequency signal having a period shorter than a period of the image signal in accordance with every pixel on the image signal in accordance with every pixel. The signal adjustment part superposes the high-frequency signal on the image signal by changing the period of the high-frequency signal corresponding to the period of the image signal.

### BRIEF DESCRIPTION OF DRAWINGS

FIG. 1 is a view showing the electrical constitution and the optical constitution of an image display device according to an embodiment of the present invention;

FIG. 2 is a view showing a scanning range in which a laser beam is scanned by a scanning part shown in FIG. 1;

FIG. 3 is a block diagram showing the constitution of a beam source part shown in FIG. 1;

FIG. 4 is a graph showing an input-output characteristic of a semiconductor laser;

FIG. 5 is a graph for explaining the input-output characteristic when a high-frequency signal is superposed on an image signal;

FIG. 6 is a graph for explaining the input-output characteristic when the high-frequency signal is superposed on the image signal;

FIG. 7 is a graph for explaining the input-output characteristic when the high-frequency signal is superposed on the image signal;

FIG. 8 is a block diagram showing the constitution of a signal generation part and a signal adjustment part shown in FIG. 1;

FIG. 9 is a view showing one example of a control table;

FIG. 10 is a view showing a state of a dot clock and a high-frequency signal in the main scanning direction;

FIG. 11A is an undesired radiation state of the related art and an undesired radiation state of the constitution shown in FIG. 1;

FIG. 11B is an undesired radiation state of the related art and an undesired radiation state of the constitution shown in FIG. 1;

FIG. 12 is a view showing the constitution of another high-frequency signal generation circuit; and

FIG. 13 is a view showing the constitution of still another high-frequency signal generation circuit.

### DESCRIPTION

Hereinafter, a mode for carrying out the present invention (hereinafter referred to as “embodiment”) is explained in conjunction with drawings. The image display device according to this embodiment is an optical scanning type image display device. In the image display device, laser beams whose intensities are modulated in response to an image signal are irradiated from laser beam sources, the laser beams are scanned by a scanning part in the two-dimensional directions, and the scanned laser beams are projected on a projecting object thus displaying a color image.

Although the explanation of the embodiment is made hereinafter by taking a retinal scanning display (hereinafter referred to as RSD) as an example, the embodiment is also applicable to a screen projection type image display device or the like.

### 1. Electrical Constitution and Optical Constitution of RSD

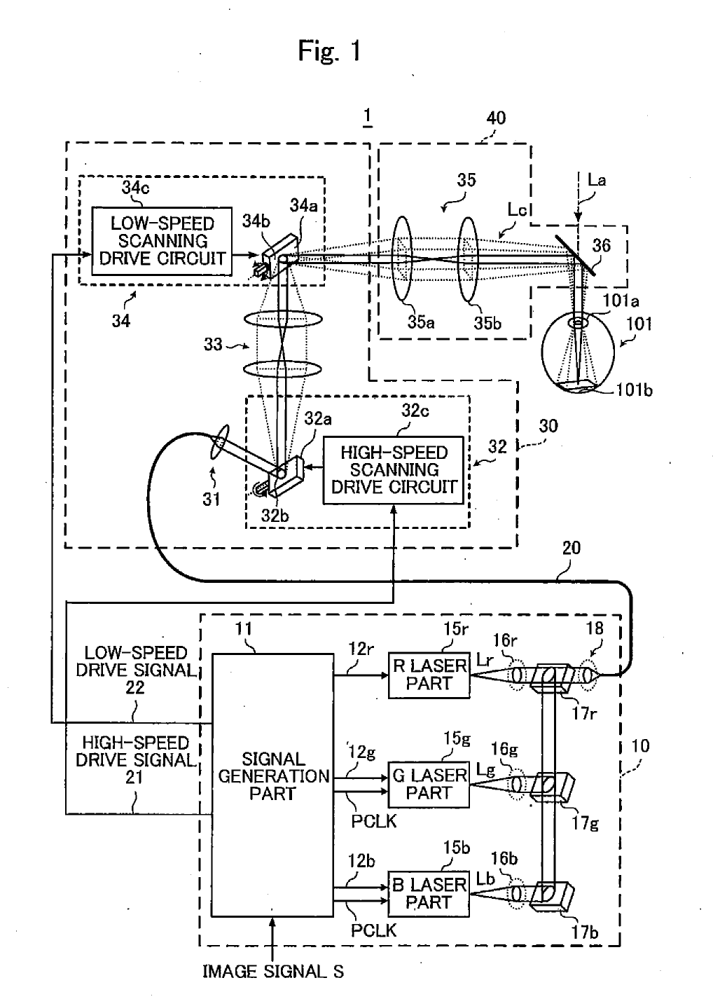

The electrical constitution and the optical constitution of the RSD according to this embodiment are explained in conjunction with FIG. 1.

As shown in FIG. 1, the RSD 1 according to this embodiment includes a beam source part 10, an optical fiber 20, a scanning part 30 and a projection part 40.

The beam source part 10 includes a signal generation part 11, laser parts 15r, 15g, 15b, collimation optical systems 16r, 16g, 16b, dichroic mirrors 17r, 17g, 17b and a coupling optical system 18.

Based on the image signal S to be inputted, the signal generation part 11 generates image signals (pixel signals) which respectively constitute elements for forming an image and correspond to respective colors of three primary colors for every pixel. That is, the signal generation part 11 generates and outputs an R (red) image signal 12r, a G (green) image signal 12g and a B (blue) image signal 12b as the image signals for respective colors. Further, the signal generation part 11 outputs a high-speed drive signal 21 which is used in the high-speed scanning part 32, and a low-speed drive signal 22 which is used in the low-speed scanning part 34 respectively.

The R laser part 15r, the G laser part 15g and the B laser part 15b respectively irradiate laser beams whose intensities are modulated in response to the R image signal 12r, the G image signal 12g and the B image signal 12b which are respectively outputted from the signal generation part 11.

An R (red) laser beam Lr, a G (green) laser beam Lg, a B (blue) laser beam Lb irradiated from the respective laser parts 15r, 15g, 15b are collimated by the collimation optical systems 16r, 16g, 16b respectively and, thereafter, the collimated laser beams Lr, Lg, Lb are incident on the dichroic mirrors 17r, 17g, 17b respectively. Thereafter, the respective laser beams of three primary colors are reflected on or are allowed to pass through the dichroic mirrors 17r, 17g, 17b selectively corresponding to wavelengths thereof, arrive at the coupling optical system 18, and are synthesized by the coupling optical system 18. Then, the synthesized laser beams are irradiated to the optical fiber 20. In this manner, the laser beams which are irradiated to the optical fiber 20 constitute an image light Lc which is obtained by synthesizing the laser beams of respective colors whose intensities are modulated.

The scanning part 30 is constituted of a collimation optical system 31, the high-speed scanning part 32, a first relay optical system 33, and the low-speed scanning part 34.

The collimation optical system 31 collimates the laser beams which are generated by the beam source part 10 and are irradiated through the optical fiber 20.

The high-speed scanning part 32 and the low-speed scanning part 34, to bring the laser beams incident from the optical fiber 20 into a state where the laser beams can be projected onto a retina 101b of a user as an image, scan the laser beams in the main scanning direction as well as in the sub scanning direction. The high-speed scanning part 32 scans the laser beams which are incident on the high-speed scanning part 32 after being collimated by the collimation optical system 31 in the main scanning direction in a reciprocating manner for displaying an image. Further, the low-speed scanning part 34 scans the laser beams which are scanned in the main scanning direction by the high-speed scanning part 32 and are incident on the low-speed scanning part 34 by way of the first relay optical system 33 in the sub scanning direction approximately orthogonal to the main scanning direction.

The high-speed scanning part 32 includes a resonance-type deflecting element 32a having a reflection mirror 32b which scans the laser beams in the main scanning direction by swinging, and a high-speed scanning drive circuit 32c which, based on a high-speed drive signal 21, generates a drive signal for resonating the deflecting element 32a so as to swing the reflection mirror 32b of the deflecting element 32a. The reflection mirror 32b of the deflecting element 32a is swung in a sinusoidal manner due to resonance oscillations.

On the other hand, the low-speed scanning part 34 includes a non-resonance-type deflecting element 34a having a reflection mirror 34b which scans the laser beams in the sub scanning direction by swinging, and a low-speed scanning drive circuit 34c which, based on a low-speed drive signal 22, generates a drive signal for forcibly swinging the reflection mirror 34b of the deflecting element 34a in a non-resonant state. The low-speed scanning part 34 scans the laser beams for forming the image in the sub scanning direction toward a final scanning line from a first scanning line for every 1 frame of an image to be displayed. Here, “scanning line” means one scanning in the main scanning direction performed by the high-speed scanning part 32.

In this embodiment, a galvanometer mirror is used as the deflecting elements 32a, 34a. However, any one of a piezoelectric drive method, an electromagnetic drive method, an electrostatic drive method and the like may be used as a drive method of the deflecting elements 32a, 34a provided that the drive method can swing or rotate the reflection mirrors 32b, 34b for scanning the laser beams.

The first relay optical system 33 is arranged between the high-speed scanning part 32 and the low-speed scanning part 34, and relays the laser beams. The first relay optical system 33 converges the laser beams which are scanned in the main scanning direction by the reflection mirror 32b of the deflecting element 32a on the reflection mirror 34b of the deflecting element 34a. Further, the converged laser beams are scanned in the sub scanning direction by the reflection mirror 34b of the deflecting element 34a. Here, the horizontal direction of the image to be displayed is assumed as the main scanning direction and the vertical direction of the image to be displayed is assumed as the sub scanning direction. However, the vertical direction of the image to be displayed may be assumed as the main scanning direction and the horizontal direction of the image to be displayed may be assumed as the sub scanning direction.

The projection part 40 includes a second relay optical system 35 and a half mirror 36. The laser beams which are scanned by the deflecting element 34a passes through the second relay optical system 35 in which two lenses 35a, 35b having a positive refractive power are arranged in series, are reflected on the half mirror 36 positioned in front of an eye 101, and are incident on a pupil 101a of the user. Due to such an operation, the image corresponding to the image signal S is projected onto the retina 101b and hence, the user recognizes the laser beams (image light Lc) which is incident on the pupil 101a as an image. The half mirror 36 also allows the external light La to pass therethrough and to be incident on the pupil 101a of the user. Accordingly, the user can visually recognize an image which is obtained by superposing the image based on the image light Lc on the scenery based on the external light La.

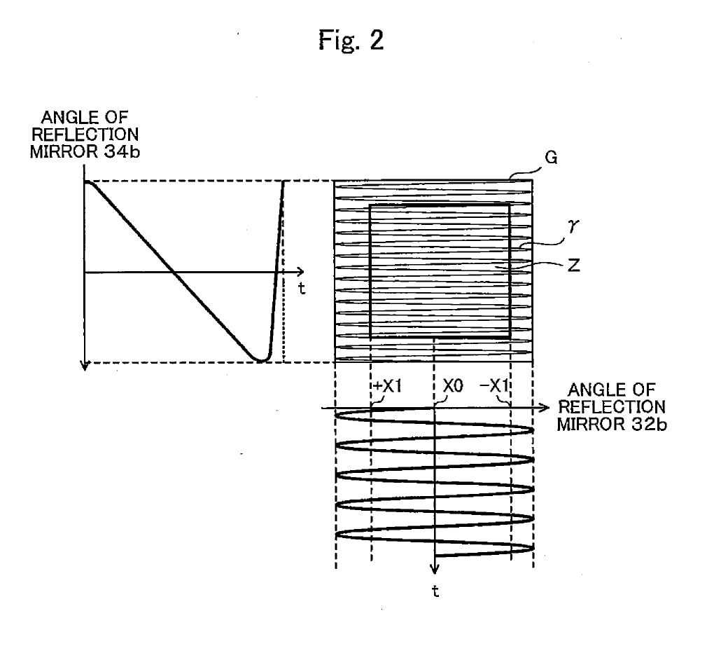

FIG. 2 shows the relationship between a maximum scanning range G and an effective scanning range Z obtained by the deflecting elements 32a, 34a of the high-speed scanning part 32 and the low-speed scanning part 34. Here, the “maximum scanning range G” means a maximum range where a laser beam can be scanned by the deflecting elements 32a, 34a. The image light Lc which is the laser beam whose intensity is modulated in response to an image signal S is irradiated from the beam source part 10 at timing where the scanning positions of the deflecting elements 32a, 34a fall in the effective scanning range Z within the maximum scanning range G. Due to such processing, the image light Lc is scanned within the effective scanning range Z by the deflecting elements 32a, 34a, and the image light Lc for 1 frame is scanned. This scanning is repeated for every image of 1 frame. In FIG. 2, a trajectory γ of the laser beam scanned by the deflecting elements 32a, 34a assuming that the laser beam is constantly irradiated from the beam source part 10 is virtually shown. However, the number of scanning lines in the main scanning direction in the scanning performed by the deflecting element 32a is several hundreds to several thousands for every 1 frame so that the trajectory γ of the laser beam is described in a simplified manner in FIG. 2.

In the scanning part 30 according to this embodiment, the scanning in the main scanning direction is performed at a speed corresponding to a scanning position by the resonance-type deflecting element 32a so that the scanning is performed at a non-constant speed. That is, in the scanning in the main scanning direction, a scanning speed becomes maximum at the center of scanning (an angle made by the reflection mirror 32b of the deflecting element 32a being X0), and the scanning speed is gradually lowered as the scanning position goes away toward a peripheral portion from the center. Assuming that a laser beam is irradiated from the beam source part 10 when the angle of the reflection mirror 32b falls within an angle range from +X1 to −X1, it is necessary to irradiate the laser beam corresponding to the respective pixels (the number of pixels being K) from the beam source part 10 at respective angle positions obtained by dividing the angle range +X1 to −X1 by the number of pixels K in the main scanning direction. For this end, the signal generation part 11 performs the arc-sine correction such that dot clocks having different periods corresponding to the respective scanning positions of the high-speed scanning part 32 are generated, and an image signal is outputted based on the dot clocks in accordance with every pixel.

### 2. Specific Constitution of Beam Source Part 10

Next, the specific constitution of the beam source part 10 is further explained in conjunction with drawing. The beam source part 10 is, as described previously, constituted of the signal generation part 11, and the laser parts 15r, 15g, 15b. Firstly, the laser parts 15r, 15g, 15b are explained.

(Laser Part 15r, 15g, 15b)

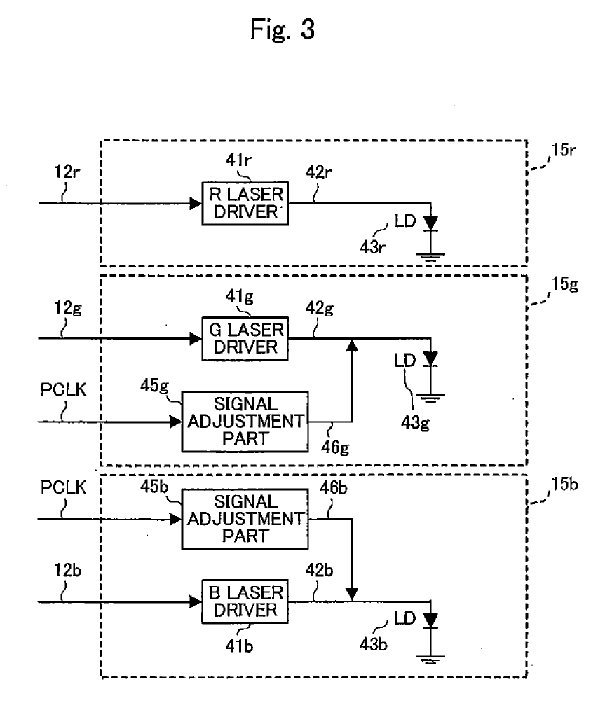

As shown in FIG. 3, the R laser part 15r is constituted of an R laser driver 41r and an R laser diode 43r. The R laser driver 41r generates an image signal 42r having a current value corresponding to a voltage value of the R image signal 12r outputted from the signal generation part 11, and supplies the image signal 42r to the R laser diode 43r. A red laser beam having intensity corresponding to the image signal 42r is irradiated from the R laser diode 43r. That is, the R laser diode 43r irradiates the red laser beam having intensity corresponding to the R image signal 12r outputted from the signal generation part 11.

The G laser part 15g is constituted of a G laser driver 41g, a G laser diode 43g, and a signal adjustment part 45g. The G laser driver 41g generates an image signal 42g having a current value corresponding to a voltage value of the G image signal 12g outputted from the signal generation part 11, and supplies the image signal 42g to the G laser diode 43g. The signal adjustment part 45g generates a high-frequency signal 46g having a current value of predetermined amplitude, and supplies the high-frequency signal 46g to the G laser diode 43g. An electric current which is formed by superposing the high-frequency signal 46g on the image signal 42g outputted from the G laser driver 41g is inputted to the G laser diode 43g, and the G laser diode 43g irradiates a green laser beam having intensity corresponding to the electric current.

The B laser part 15b has the substantially equal constitution as the G laser part 15g, and is constituted of a B laser driver 41b, a B laser diode 43b, and a signal adjustment part 45b. The B laser driver 41b generates an image signal 42b having a current value corresponding to a voltage value of a B image signal 12b outputted from the signal generation part 11, and supplies the image signal 42b to the B laser diode 43b. The signal adjustment part 45b generates a high-frequency signal 46b having a current value of predetermined amplitude, and supplies the high-frequency signal 46b to the B laser diode 43b. An electric current which is formed by superposing the high-frequency signal 46b on the image signal 42b outputted from the B laser driver 41b is inputted to the B laser diode 43b, and the B laser diode 43b irradiates a blue laser beam having intensity corresponding to the electric current.

### (Superposition of High-Frequency Signal)

Here, the reason why the laser parts 15g, 15b are provided with the signal adjustment parts 45g, 45b out of the laser parts 15r, 15g, 15b is explained.

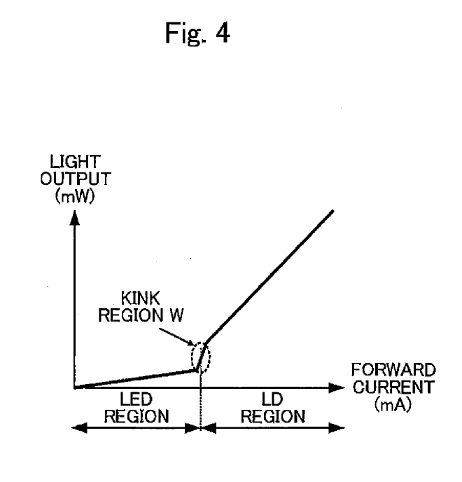

With respect to the G laser diode 43g and the B laser diode 43b, as shown in FIG. 4, an input-output characteristic (current-light output characteristic) has a kink region W where the input-output characteristic is steeply changed so that a bent portion is formed thus collapsing linearity thereof. That is, in addition to a first region where the increase/decrease of output intensity of light with respect to the increase/decrease of an electric current is gentle and a second region where the increase/decrease of output intensity of light with respect to the increase/decrease of an electric current is steep, the input-output characteristic also has the kink region W which is a third region where the increase/decrease of output intensity of light is steeper than the increase/decrease of output intensity of light in the second region between the first region and the second region. Accordingly, with the use of the image signals 12g, 12b which are outputted from the signal generation part 11 with current values corresponding to gradation levels, the low gradation levels cannot be accurately reproduced.

In view of the above, the signal adjustment part 45g which superposes the high-frequency signal 46g on the image signal 42g inputted to the G laser diode 43g, and the signal adjustment part 45b which superposes the high-frequency signal 46b on the image signal 42b inputted to the B laser diode 43b are provided. For the sake of convenience, the explanation is made hereinafter assuming that the G laser diode 43g and the B laser diode 43b have the same input-output characteristic. However, it is not always necessary that the G laser diode 43g and the B laser diode 43b have the same input-output characteristic, and these laser diodes 43g, 43b usually have different input-output characteristics. Further, either one of the laser diodes 43g, 43b may be expressed as “laser diode 43”, either one of the image signals 42g, 42b may be expressed as “image signal 42”, either one of the signal adjustment parts 45g, 45b may be expressed as “signal adjustment part 45”, and either one of the high-frequency signals 46g, 46b may be expressed as “high-frequency signal 46”.

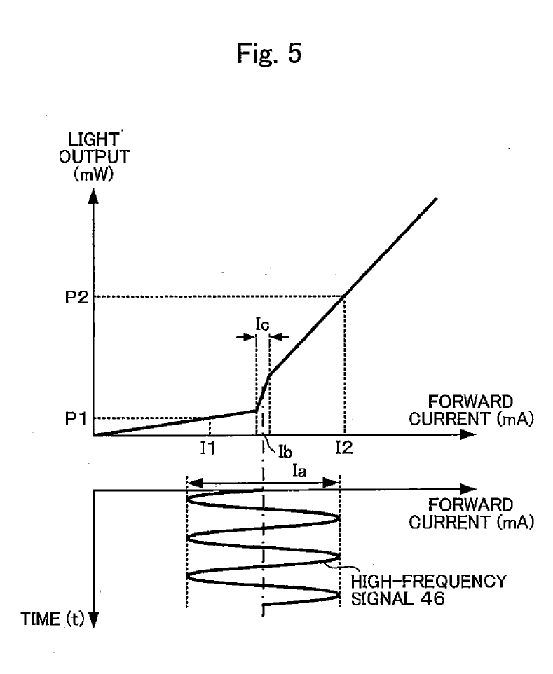

When the high-frequency signal 46 is superposed on the image signal 42 inputted to the laser diode 43, the intensity of the laser beam irradiated from the laser diode 43 is changed corresponding to a change of amplitude of the high-frequency signal 46. For example, assume that the high-frequency signal 46 having current amplitude Ia is inputted to the laser diode 43 having the input-output characteristic shown in FIG. 4 such that the high-frequency signal 46 is superposed on the image signal 42 having a current value Ib as shown in FIG. 5. Here, a current value of an electric current inputted to the laser diode 43 is periodically increased or decreased between a current value I1 (−Ib−Ia/2) and a current value I2 (=Ib+Ia/2). Accordingly, intensity of light irradiated from the laser diode 43 is also changed between an intensity value P1 and an intensity value P2.

In this manner, although the intensity of the laser beam irradiated from the laser diode 43 is changed corresponding to the change of the amplitude of the high-frequency signal 46 when the high-frequency signal 46 is superposed on the image signal 42, the brightness of each pixel visually recognized by a user becomes the brightness corresponding to intensity obtained by averaging the changing intensities.

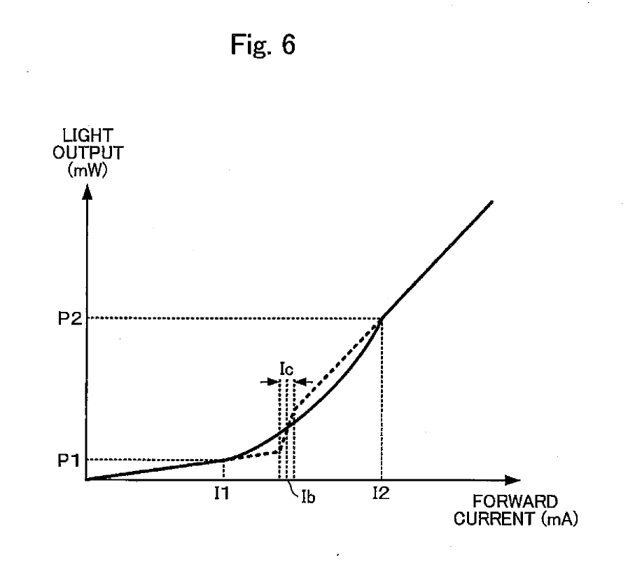

Accordingly, when the high-frequency signal 46 is superposed on the image signal 42, the input-output characteristic of the laser diode 43 is regarded as a characteristic which changes intensity of light corresponding to a current value of the image signal 42 as indicated by a solid line shown in FIG. 6. Hereinafter, such an input-output characteristic is referred to as an apparent input-output characteristic. A broken line shown in FIG. 6 indicates the input-output characteristic of the laser diode 43 when the high-frequency signal 46 is not superposed on the image signal 42.

In the image display device 1 according to this embodiment, the influence of the kink region W exerted on the input-output characteristic of the laser diode 43 is suppressed by superposing the high-frequency signal 46 on the image signal 42 thus approximating the relationship between the current value of the image signal 42 and the intensity of the laser beam to the proportional relationship. Due to such processing, the allocation of the current value of the image signal 42 at the low gradation level can be performed easily.

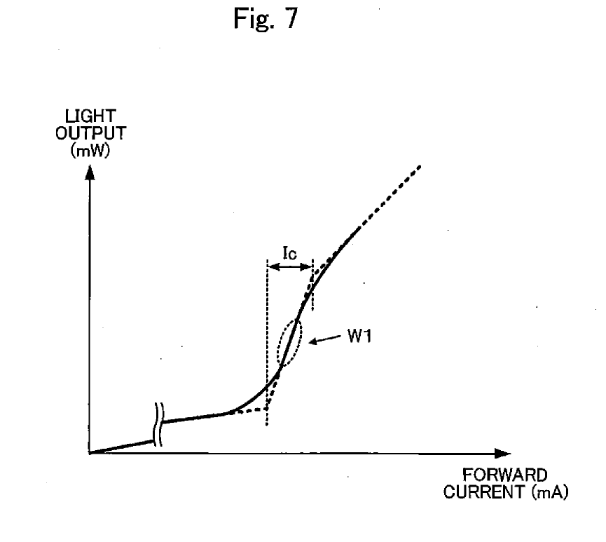

Further, in the image display device 1, it is necessary to set the current amplitude of the high-frequency signal 46 superposed on the image signal 42 to not less than a width Ic of the kink region W. That is, it is necessary that a current range of the image signal 42 where a current value is changed due to the superposition of the high-frequency signal 46 covers a range of the kink region W. It is because when the width of the high-frequency signal 46 is smaller than the width Ic of the kink region W, as shown in FIG. 7, a region W1 where the influence exerted by the kink region cannot be suppressed is generated.

In the image display device 1, the gradation level is allocated such that the gradation level assumes a black level when a current value of the image signal 42 is a current value I1 and the gradation level assumes a white level when the current value of the image signal 42 is a current value I2. This is because that, as shown in FIG. 6, although the degree of increase of light intensity with respect to the increase of the current value is gently increased from the current value I1 to the current value I2, the degree of increase of the light intensity is suddenly lowered when the current value becomes equal to or more than the current value I2, and the degree of increase of the light intensity is suddenly elevated when the current value becomes the current value I1 from a current value less than the current value I1. Due to such processing, it is possible to allocate the gradation level in a region where the current value of the image signal 42 and the intensity of the laser beam exhibit the continuous degree of increase.

That is, assuming the intensity of the laser beam outputted from the laser diode 43 when the high-frequency signal 46 is superposed on the image signal 42 as first intensity and the intensity of the laser beam outputted from the laser diode 43 when the high-frequency signal 46 is not superposed on the image signal 42 as second intensity, the signal generation part 11 sets the gradation level corresponding to the lower current value I1 out of the current values I1, I2 of the image signal 42 where the first intensity and the second intensity agree with each other as a black level. On the other hand, the signal generation part 11 sets the gradation level corresponding to the higher current value I2 out of the current values I1, I2 of the image signal 42 where the first intensity and the second intensity agree with each other as a white level. Here, the black level implies, for example, the gradation level “0” at which the brightness is the lowest when the gradation of the image signal 42 is constituted of 256 gradations (gradation levels: 0 to 255), and the white level implies, for example, the gradation level “255” at which the brightness is the highest when the gradation of the image signal 42 is constituted of 256 gradations.

In this manner, in the image display device 1 according to this embodiment, the influence of the kink region W exerted on the input-output characteristic of the laser diode can be suppressed by superposing the high-frequency signal 46 on the image signals 42 respectively thus approximating the relationship between the current value of the image signal 42 and the intensity of the laser beam to the proportional relationship. Accordingly, the allocation of the current value of the image signal 42 at the low gradation level can be performed easily. Accordingly, even when the kink region W is present in the input-output characteristic of the laser beam source, it is possible to reproduce the low gradation level with high accuracy.

### (Signal Generation Part 11 and Signal Adjustment Part 45)

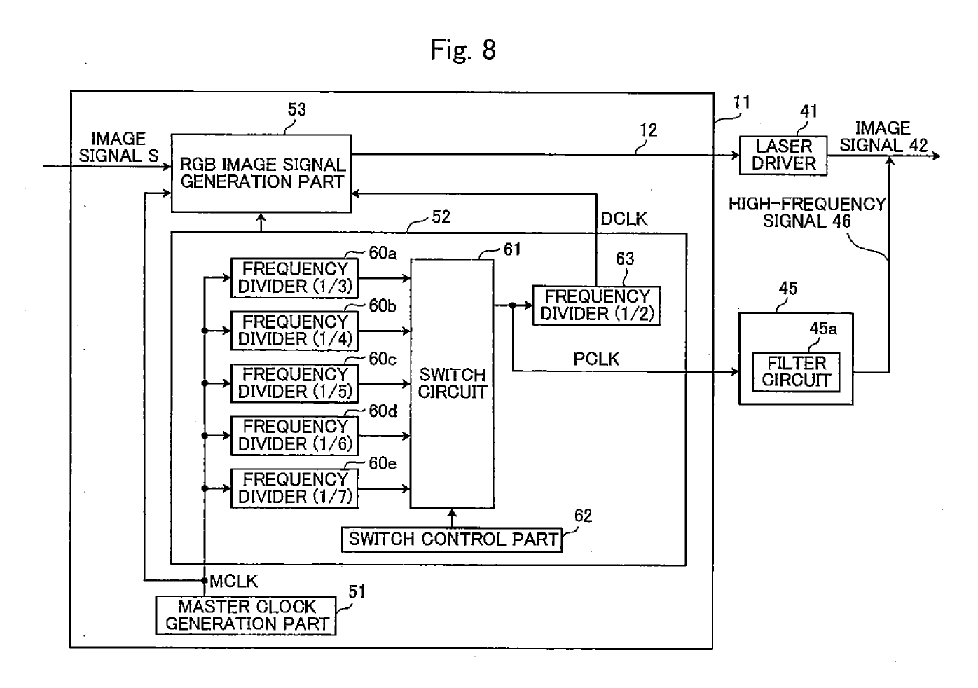

Next, with respect to the constitution of the signal generation part 11 and the constitution of the signal adjustment part 45, the constitution for generating an image signal 12 and a high-frequency signal 46 is explained in conjunction with FIG. 8.

As shown in FIG. 8, the signal generation part 11 includes a master clock generation part 51, a dot clock generation part 52, and an RGB image signal generation part 53.

The master clock generation part 51 generates a master clock which is a basic clock of the RSD1, and outputs the master clock to the dot clock generation part 52 and the RGB image signal generation part 53.

The dot clock generation part 52 includes frequency dividers 60a to 60e, a frequency divider 63, a switch circuit 61, and a switch control part 62. The dot clock generation part 52 generates a dot clock DCLK having a clock width corresponding to a scanning speed of the high-speed scanning drive circuit 32c and a clock PCLK for generating a high-frequency signal. The arc-sine correction is performed by generating the dot clock DCLK. That is, even when a laser beam is scanned at a speed corresponding to a scanning position by the resonance-type deflecting element 32a, an image can be displayed with a pixel distance set at equal intervals in the main scanning direction. Here, “corresponding to a scanning speed of the high-speed scanning drive circuit 32c” means, in other words, “corresponding to each angle position (scanning position) obtained by equally dividing an angle range +X1 to −X1 of the reflection mirror 32b of the deflecting element 32a by the number of pixels K in the main scanning direction”.

In the dot clock generation part 52, a frequency divider corresponding to a scanning speed of the high-speed scanning part 32 is selected out of the frequency dividers 60a to 60e which constitute first frequency dividers by the switch control part 62, and an output of the frequency divider is outputted from the switch circuit 61. The output from the switch circuit 61 is further frequency-divided by the frequency divider 63 which constitutes a second frequency divider, and a dot clock DCLK is outputted from the frequency divider 63. The frequency dividers 60a to 60e are respectively configured to frequency-divide the master clock MCLK at different frequency dividing ratios so that the dot clock DCLK corresponding to a scanning speed of the high-speed scanning part 32 is generated. Information on the scanning speed of the high-speed scanning part 32 is notified to the dot clock generation part 52 from a detection part (not shown in the drawing) which detects an angle of the reflection mirror 32b of the deflecting element 32a, for example. The detection part may be constituted of a light detection part which detects a laser beam scanned by the high-speed scanning part 32, and an arithmetic operation part which acquires a current scanning speed or a current scanning position at the high-speed scanning part 32 based on a detection result of the laser beam by the light detection part and notifies the acquired scanning speed or the scanning position to the dot clock generation part 52. Further, the detection part may be constituted such that a piezoelectric element is mounted on a beam (not shown in the drawing) which rotatably supports the reflection mirror 32b, and a current scanning speed or a current scanning position at the high-speed scanning part 32 is acquired by detecting a state of the beam by the piezoelectric element, and the current scanning speed or the current scanning position is notified to the dot clock generation part 52.

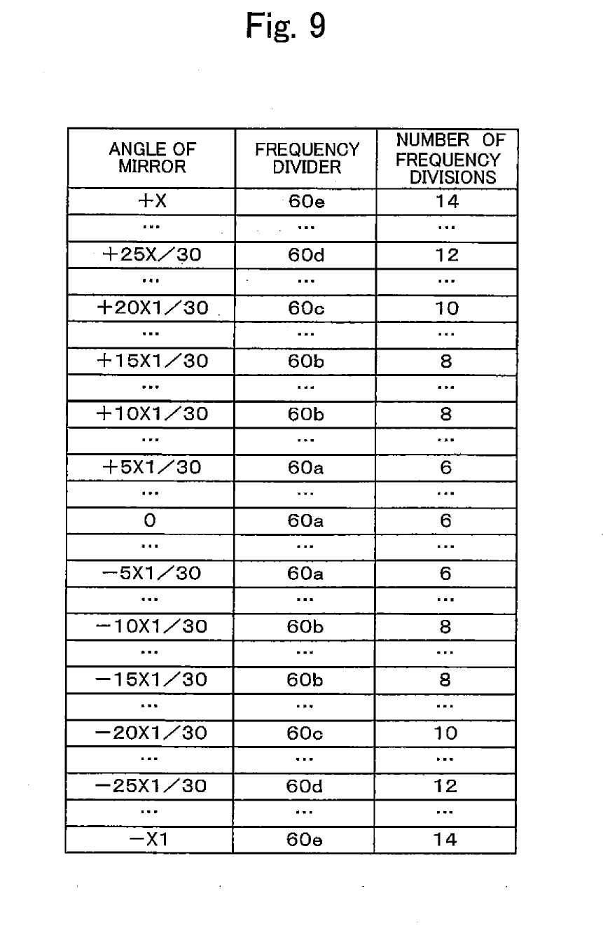

In the dot clock generation part 52 according to this embodiment, frequency dividing ratios of the frequency dividers 60a, 60b, 60c, 60d, 60e, 63 are set to 1/3, 1/4, 1/5, 1/6, 1/7, 1/2 respectively. Accordingly, dot clocks DCLK which are obtained by frequency-dividing the master clocks DCLK into 1/6 to 1/14 are generated. The switch control part 62 of the dot clock generation part 52 controls the switch circuit 61 based on the control table stored in the inside thereof. For example, assuming that scanning of a laser beam corresponding to an image signal 42 is performed when an angle range of the reflection mirror 32b is +X1 to −X1 and the number of pixels K is 60, the control table shown in FIG. 9 is stored in the switch control part 62. In the table shown in FIG. 9, for example, when an angle of the reflection mirror 32b is ±X1, an output of the frequency divider 60a is selected so that dot clock DCLK with the number of frequency divisions of 14 (dot clock amounting to 14 periods of master clocks MCLK) are outputted from the dot clock generation part 52. On the other hand, for example, when the angle of the reflection mirror 32b is ±0, an output of the frequency divider 60e is selected so that dot clock DCLK with the number of frequency divisions of 6 (dot clock amounting to 6 periods of master clocks MCLK) are outputted from the dot clock generation part 52.

Further, a clock PCLK outputted from the switch circuit 61 is inputted to the signal adjustment part 45. The signal adjustment part 45 includes a filter circuit 45a. By filtering the clock PCLK in the filter circuit 45a, harmonic components of the clock PCLK are removed thus generating a high-frequency signal 46. The dot clock DCLK is a clock which is obtained by further frequency-dividing the clock PCLK into 1/2. Accordingly, the high-frequency signal 46 is a high-frequency signal with a period shorter than a period Td of the dot clock DCLK. Here, the high-frequency signal 46 has a period Th which is 1/2 times as large as the period Td of the dot clock DCLK. When the period Th of the high-frequency signal 46 is not changed corresponding to the period Td of the dot clock DCLK, unless the period Th of the high-frequency signal 46 is shortened as much as possible with respect to the period Td of the dot clock DCLK, the input-output characteristic of the laser diode 43 in response to the high-frequency signal 46 is varied corresponding to a scanning position. However, the shorter the period Th of the high-frequency signal 46, the more it is necessary to increase a frequency of the master clock MCLK and hence, the signal adjustment is not easy. In view of the above, in the RSD1 according to this embodiment, by setting the period Th of the high-frequency signal 46 to Td/n (n being a natural number) and by changing the period Th of the high-frequency signal 46 corresponding to the period Td of the dot clock DCLK, it is possible to reproduce the characteristic where the intensity is changed as indicated by a solid line shown in FIG. 6 with high accuracy even when the period Th of the high-frequency signal 46 is not shortened.

Further, the RGB image signal generation part 53 generates an R image signal 12r, a G image signal 12g, a B image signal 12b for respective colors of R (red), G (green), B (blue) from an image signal S in accordance with every pixel, and outputs these image signals 12r, 12g, 12b in synchronism with the dot clocks DCLK.

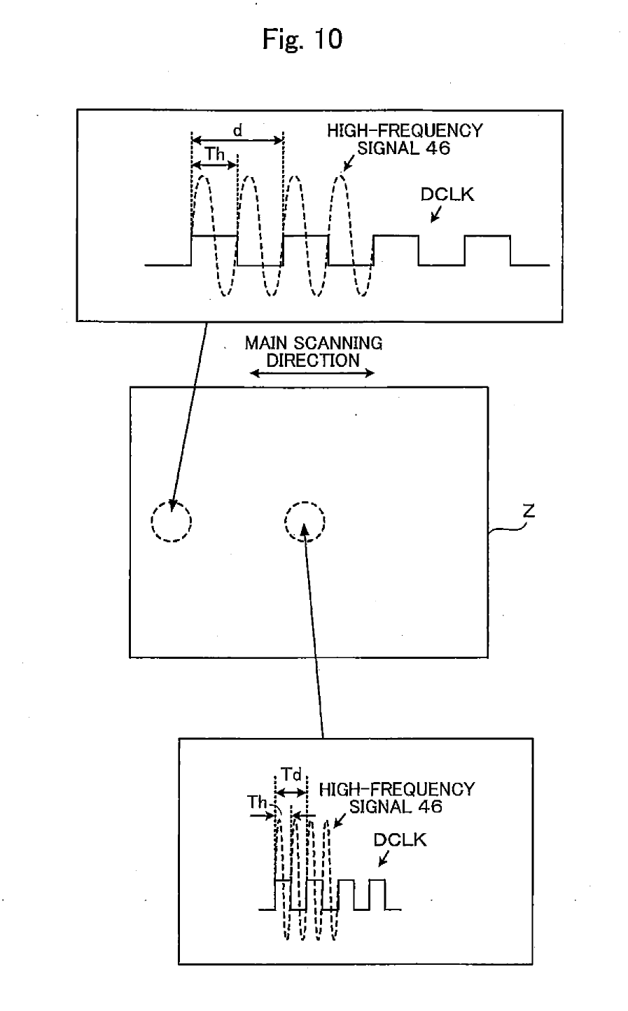

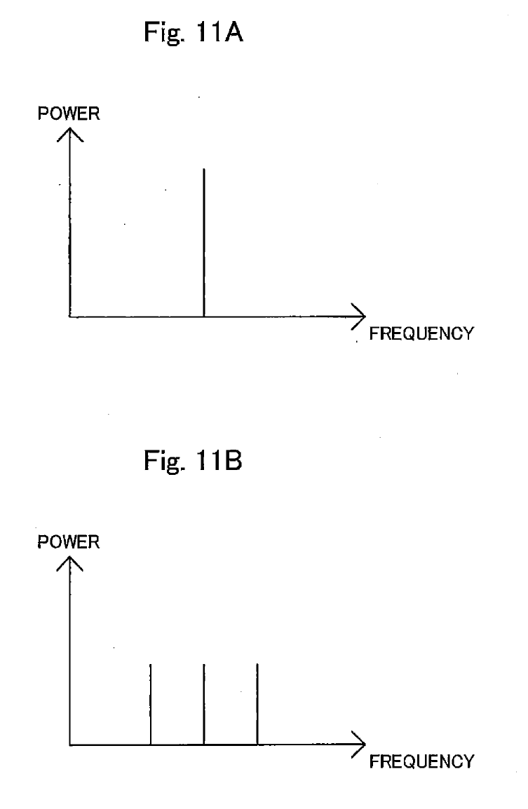

The signal generation part 11 and the signal adjustment part 45 are constituted as described above and hence, the undesired radiation due to high-frequency signals can be reduced. That is, as shown in FIG. 10, the frequency of the high-frequency signal 46 is high where a scanning position is at the center in the main scanning direction, and the frequency of the high-frequency signal 46 is gradually lowered as the scanning position goes away toward a peripheral portion from the center in the main scanning direction so that the frequency of the high-frequency signal 46 is not fixed. When the high-frequency signal 46 is fixed, the undesired radiation characteristic (EMI noises) shown in FIG. 11A appears. According to the RSD1 of this embodiment, the undesired radiation characteristic diffused as shown in FIG. 11B appears so that the influence exerted on a display due to the undesired radiation (EMI noises) can be reduced.

Further, the high-frequency signal 46 can be generated using a part of the circuit for generating dot clock DCLK in common and hence, the circuit constitution for generating the high-frequency signal 46 becomes simple, and also the period of the high-frequency signal 46 can be changed corresponding to the dot clock DCLK.

### 3. Another Embodiment

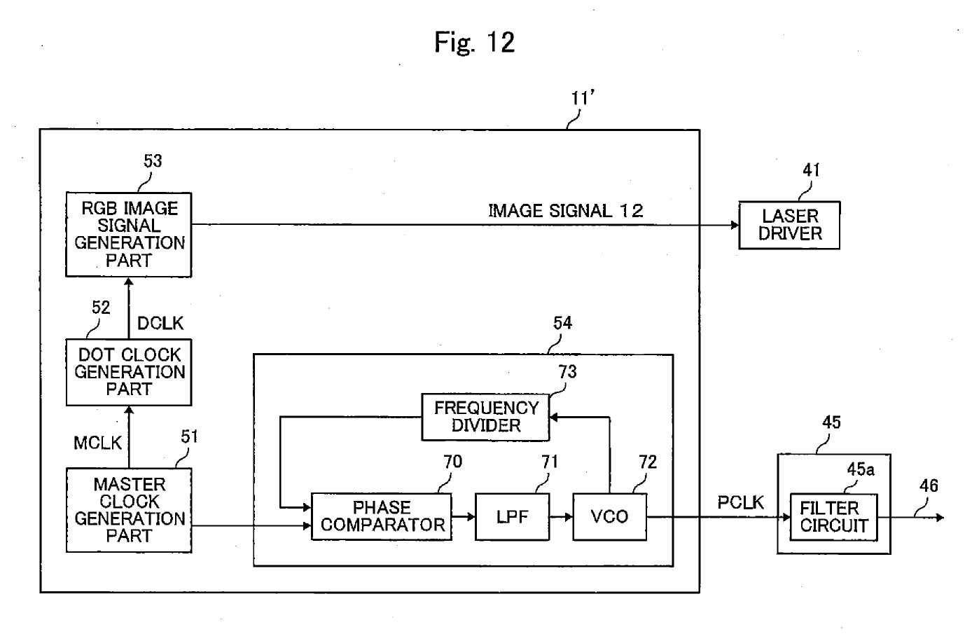

In the above-mentioned embodiment, a high-frequency signal 46 is generated using a clock PCLK outputted from the dot clock generation part 52. However, as shown in FIG. 12, a high-frequency signal 46 may be generated by a PLL circuit 54. Hereinafter, a signal generation part 11′ which includes the PLL circuit 54 is explained specifically in conjunction with drawings.

In the signal generation part 11′ shown in FIG. 12, the PLL circuit 54 includes a phase comparator 70, a low-pass filter (LPF) 71, a voltage controlled oscillator (VCO) 72 and a frequency divider 73. The phase comparator 70 compares a phase of a master clock MCLK outputted from a master clock generation part 51 and a phase of an output signal of the frequency divider 73, and outputs a result of comparison. The low-pass filter 71 filters a signal outputted from the phase comparator 70, and generates and outputs a voltage signal corresponding to the phase difference between the master clock MCLK and the output signal of the frequency divider 73. The voltage signal filtered by the low-pass filter 71 is inputted to the voltage controlled oscillator 72. The voltage controlled oscillator 72 outputs a clock PCLK with a frequency corresponding to a voltage level of the voltage signal outputted from the low-pass filter 71 to a signal adjustment part 45.

The clock PCLK which is an output from the voltage controlled oscillator 72 is inputted to the frequency divider 73, and the frequency divider 73 outputs a signal obtained by frequency-dividing the clock PCLK at a predetermined frequency dividing ratio to the phase comparator 70. Here, the frequency divider 73 frequency-divides the clock PCLK at a frequency dividing ratio corresponding to a scanning speed of the high-speed scanning part 32. Information on the scanning speed of the high-speed scanning part 32 is notified to the frequency divider 73 from a detection part (not shown in the drawing) which detects an angle of a reflection mirror 32b of a deflecting element 32a, for example.

In the PLL circuit 54 having the above-mentioned constitution, the frequency of the clock PCLK outputted from the voltage controlled oscillator 72 is expressed by N (1/frequency dividing ratio)×fm (frequency of master clock MCLK). A frequency dividing ratio of the frequency divider 73 is changed corresponding to the scanning speed of the high-speed scanning part 32 and hence, the frequency of the clock PCLK outputted from the voltage controlled oscillator 72 is changed corresponding to the scanning speed of the high-speed scanning part 32 in the same manner as the above-mentioned signal generation part 11. The frequency divider 73 shown in FIG. 12 may be constituted of, in the same manner as the dot clock generation part 52 shown in FIG. 8, a plurality of frequency dividers, a switch circuit and a switch control part, for example.

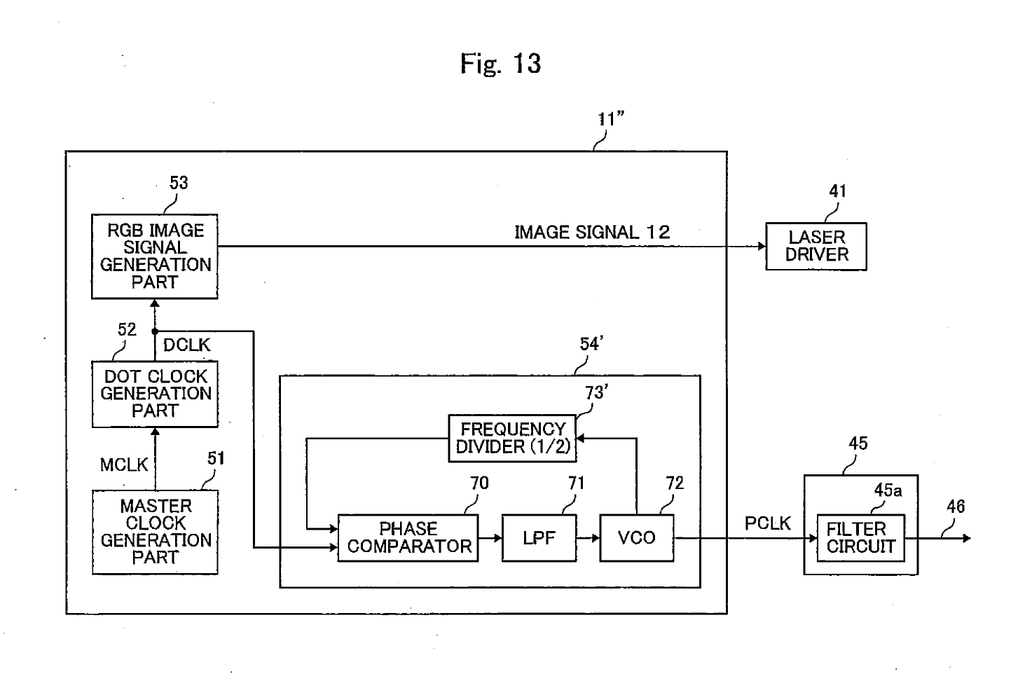

Further, as shown in FIG. 13, a signal generation part 11″ may be provided with a PLL circuit 54′ which constitutes a multiplying circuit for multiplying a dot clock DCLK.

As shown in FIG. 13, the PLL circuit 54′ includes, in the same manner as the PLL circuit 54, a phase comparator 70, a low-pass filter 71, a voltage controlled oscillator 72 and a frequency divider 73′. The phase comparator 70, the low-pass filter 71 and the voltage controlled oscillator 72 are substantially equal to corresponding parts of the PLL circuit 54 and hence, the explanation of these parts is omitted.

A frequency dividing ratio of the frequency divider 73′ is set to 1/2, for example, so that a frequency of a clock PCLK outputted from the voltage controlled oscillator 72 is twice as large as a frequency of a dot clock DCLK, and is changed corresponding to a scanning speed of a high-speed scanning part 32.

The detection part may be constituted of a light detection part which detects a laser beam scanned by the high-speed scanning part 32, and an arithmetic operation part which acquires a current scanning speed or a current scanning position at the high-speed scanning part 32 based on a detection result of the laser beam by the light detection part and notifies the acquired scanning speed or the scanning position to the dot clock generation part 52. Further, the detection part may be constituted such that a piezoelectric element is mounted on a beam (not shown in the drawing) which rotatably supports the reflection mirror 32b, a current scanning speed or a current scanning position at the high-speed scanning part 32 is acquired by detecting a state of the beam by the piezoelectric element, and the acquired scanning speed or the scanning position is notified to the dot clock generation part 52.

The present invention has been explained in conjunction with the above-described embodiments. According to the above-mentioned embodiments, the present invention can acquire the following advantageous effects.

(1) The image display device includes the laser diode 43 (laser beam source) which irradiates a laser beam having intensity corresponding to the image signal 12, the scanning part 30 which scans the laser beam which is irradiated from the laser diode 43 at a scanning speed corresponding to a scanning position, the signal generation part (signal generation part 11 and laser driver 41) which generates the image signal 42 at a period corresponding to the scanning speed of the scanning part 30 in accordance with every pixel, and the signal adjustment part 45 which superposes the high-frequency signal 46 having the period Th shorter than the period Td of the image signal 42 in accordance with every pixel on the image signal 42 in accordance with every pixel. That is, by superposing the high-frequency signal 46 having amplitude equal to or more than a width of a kink region where an input-output characteristic of a laser beam source is steeply changed on a pixel signal and hence, a steep change which occurs in the kink region can be converted into the gentle change. Further, the signal adjustment part 45 superposes the high-frequency signal 46 on the image signal 42 by changing the period Th of the high-frequency signal 46 corresponding to the period Td of the image signal 42 and hence, it is possible to suppress the undesired radiation (EMI noises) due to the high-frequency signal.

(2) The signal generation part 11 includes the frequency dividers 60a to 60e (first frequency dividers) which generate a clock by frequency-dividing a predetermined master clock MCLK, and the frequency divider 63 (second frequency divider) which generates the dot clock DCLK by further frequency-dividing the clock outputted from the frequency dividers 60a to 60e, and generates the image signal 12 based on the dot clock DCLK in accordance with every pixel. In this manner, the high-frequency signal 46 is generated using a part of the circuit for generating the dot clock DCLK in common and hence, the circuit constitution for generating the high-frequency signal 46 becomes simple, and also the period of the high-frequency signal 46 can be changed corresponding to the dot clocks DCLK.

(3) The signal generation part 11 includes the dot clock generation part 52 (frequency dividing circuit) which generates the dot clock DCLK by frequency-dividing the predetermined master clock MCLK and generates the image signal 12 based on the dot clock DCLK in accordance with every pixel. Further, the signal adjustment part 45 includes the PLL circuit 54′ (multiplying circuit) which outputs the clock obtained by multiplying the dot clock DCLK, and outputs a signal corresponding to the clock PCLK outputted from the PLL circuit 54 as the high-frequency signal 46. Due to such an operation, it is possible to generate the high-frequency signal 46 with the provision of the PLL circuit 54′ (multiplying circuit) without changing the constitution of the conventional dot clock generation part 52.

(4) The signal adjustment part 45 includes the filter circuit 45a which generates the high-frequency signal 46 by filtering the clock PCLK and hence, harmonic components of the high-frequency signal 46 can be reduced whereby undesired radiation (EMI noises) can be reduced.

(5) The signal adjustment part 45 includes the PLL circuit which generates the high-frequency signal 46 based on the predetermined master clock MCLK and hence, the high-frequency signal 46 can be generated with the provision of the PLL circuit 54 without changing the constitution of the conventional dot clock generation part 52.

(6) The scanning part 30 includes the resonance-type deflection element 32a which deflects the laser beam, and scans the laser beam at a non-constant speed by swinging the reflection mirror 32b (deflection surface) of the deflection element 32a in a sinusoidal manner and hence, swing amplitude of the reflection mirror 32b can be increased with small power consumption.

(7) The image display device is an RSD in which the laser beam scanned by the scanning part 30 is incident on at least one eye of a user and an image is displayed on the eye and hence, it is possible to provide an RSD which can convert a steep change which occurs in a kink region into a gentle change, and can suppress undesired radiation (EMI noises) due to a high-frequency signal.

The above-mentioned embodiments merely constitute one example of the present invention, and the present invention is not limited by the above-mentioned embodiments. Accordingly, it is needless to say that, besides the above-mentioned embodiments, various modifications are conceivable depending on designs or the like without departing from the technical concept of the present invention. For example, although the image signal 42 is generated by the signal generation part 11, 11′, 11″ and the laser driver 41 in the above-mentioned embodiments, the image signal 42 may be outputted from the signal generation part 11, 11′, 11″ by incorporating the laser driver 41 in the inside of the signal generation part 11, 11′, 11″.

What is claimed is:

1. An image display device comprising:
a laser beam source which is configured to irradiate a laser beam having intensity corresponding to an image signal;
a scanning part which is configured to scan the laser beam which is irradiated from the laser beam source at a scanning speed corresponding to a scanning position;
a signal generation part which is configured to generate the image signal at a period corresponding to the scanning speed of the scanning part in accordance with every pixel; and
a signal adjustment part which is configured to superpose a high-frequency signal having a period shorter than a period of the image signal in accordance with every pixel on the image signal in accordance with every pixel, wherein
the signal adjustment part is configured to superpose the high-frequency signal on the image signal by changing the period of the high-frequency signal corresponding to the period of the image signal.

2. The image display device according to claim 1, wherein the signal generation part includes a first frequency divider which is configured to generate a clock by frequency-dividing a predetermined master clock, and a second frequency divider which is configured to generate a dot clock by further frequency-dividing the clock outputted from the first frequency divider, and is configured to generate the image signal based on the dot clock in accordance with every pixel, and
the signal adjustment part outputs the clock outputted from the first frequency divider or a signal corresponding to the clock as the high frequency signal.

3. The image display device according to claim 1, wherein the signal generation part includes a frequency dividing circuit which is configured to generate a dot clock by frequency-dividing a predetermined master clock and generates the image signal based on the dot clock in accordance with every pixel, and
the signal adjustment part includes a multiplying circuit which is configured to output a clock obtained by multiplying the dot clock, and outputs a clock outputted from the multiplying circuit or a signal corresponding to the clock as the high-frequency signal.

4. The image display device according to claim 2, wherein the signal adjustment part includes a filter circuit which is configured to generate the high-frequency signal by filtering the clock.

5. The image display device according to claim 1, wherein the signal adjustment part includes a PLL circuit which is configured to generate the high-frequency signal based on the predetermined master clock.

6. The image display device according to claim 1, wherein the scanning part includes a resonance-type deflection element which is configured to deflect the laser beam, and scans the laser beam at a non-constant speed by swinging a deflection surface of the deflection element in a sinusoidal manner.

7. The image display device according to claim 1, wherein the image display device is a retinal scanning display in which the laser beam scanned by the scanning part is incident on at least one eye of a user and an image is displayed on the eye.
